(19) United States
(12) Patent Application Publication
(10) Pub. No.: US 2003/0190893 A1
(43) Pub. Date: Oct. 9, 2003

(54) Mobile wireless apparatus, base station wireless apparatus, and recording medium therefor

(75) Inventors: Kazuyoshi Tari, Omiya-shi (JP); Hiroyuki Unoki, Omiya-shi (JP); Tumoru Nagira, Omiya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI MATERIALS CORPORATION, Tokyo (JP)

(21) Appl. No.: 10/439,240

(22) Filed: May 16, 2003

Related U.S. Application Data
(62) Division of application No. 09/466,191, filed on Dec. 17, 1999.

(30) Foreign Application Priority Data
Dec. 18, 1998 (JP) 10-361658

(51) Int. Cl. H04B 17/00; H04Q 7/20

(52) U.S. Cl. 455/67.13; 455/445; 455/452.1; 370/332

(57) ABSTRACT

A mobile wireless method and apparatus and wireless communication system wherein a receiving unit receives a radio signal, a PLL unit demodulates the radio signal, a storage unit stores channel information of a base station wireless apparatus and electrical field intensity information, a first data analyzing unit obtains a destination of received data and stores it in the storage unit, a second data analyzing unit obtains channel information of another base station wireless apparatus and stores the channel information in the storage unit, and an electrical field intensity measuring unit measures the electrical field intensity of the signal received by the receiving unit and stores the corresponding electrical field intensity data in the storage unit. The base station wireless apparatus transmits channel information to which an index in accordance with a distance to another base station wireless apparatus is added. Program instructions for implementing the method are stored in a computer readable medium.

CROSS REFERENCE TO RELATED APPLICATION

This application claims benefit of priority to Japanese Patent Application No. JP10-361658 filed Dec. 18, 1998, the entire content of which is incorporated by reference herein.

### BACKGROUND OF THE INVENTION

1. Field of the Invention

The present invention relates to a mobile communication system, particularly to a mobile wireless apparatus for performing wireless communication with a base station wireless apparatus.

2. Discussion of the Background

A wireless communication system is described in Japanese Patent Application No. 10-262099. This wireless communication system includes at least one wireless server that is connected to the Internet and a base station wireless apparatus. The server communicates with a mobile wireless apparatus that is connected to a terminal unit. One of the wireless server is designated as a home wireless server. Under this arrangement, the terminal unit that is connected to the mobile wireless apparatus communicates with the base station wireless apparatus within the coverage area of the base station wireless apparatus to establish via the home wireless server a link to the Internet.

The above wireless server includes a terminal authentication managing unit for authenticating, when connecting the terminal unit, a connection of the terminal unit in accordance with a registration request from the terminal unit. A terminal managing unit issues an available IP (Internet Protocol) address in accordance with an IP address issue request from the terminal unit. The terminal managing unit then registers the connection of the terminal unit.

When a registration request is made by the terminal unit to a wireless server other than the home wireless server, the above wireless server requests the home wireless server of the terminal unit via the Internet to authenticate the connection and to issue the IP address. When the home wireless server has authenticated the connection and issued the IP address, the terminal unit is permitted to connect to another wireless server, other than the home wireless server.

The above wireless server further includes a routing unit. When the terminal unit is connected to a wireless server other than the home wireless server, the routing unit forwards, upon reception of packet data that is addressed to the terminal unit by the wireless server to which the terminal unit had been previously connected, the packet data to the wireless server to which the terminal unit is currently connected based on the IP address obtained from the home wireless server.

When the packet data that is addressed to the terminal unit is forwarded from the wireless server in which the terminal unit is connected to a wireless server other than the home wireless server, the above wireless server notifies a host on the Internet about the wireless server to which the terminal unit is currently connected. After this notification, the above wireless server directly transmits packet data to the wireless server to which the terminal unit is connected, without the intermediary of the wireless server to which the terminal unit had been previously connected.

In a typical example of a general wireless communication system, a predetermined bandwidth is allocated for operation at a radio frequency, along with predetermined control channels. When a mobile wireless apparatus moves outside the in-service area that is covered by the general wireless communication system, the control channels are scanned one after another to detect a connectable channel. This channel detecting method disadvantageously requires considerable processing time for channel detection. Further, the above wireless communication system does not utilize predetermined control channels, the mobile wireless apparatus necessarily must store channel information (e.g., frequency, which should be detected), consuming precious memory. In addition, channel detection is influenced by the selection of base station wireless apparatuses for storing channel information thereof.

### SUMMARY OF THE INVENTION

Accordingly, it is an object of the present invention to provide a mobile wireless apparatus for detecting a receivable channel based on pre-obtained electrical field intensity information when the mobile wireless apparatus moves outside an in-service area, and a base station wireless apparatus for transmitting a packet to which information is added so that the mobile wireless apparatus may preferably detect a nearer base station wireless apparatus around the periphery.

In one aspect of the present invention, there is provided a mobile wireless apparatus for performing wireless communication with a base station wireless apparatus, thus establishing a link between a terminal unit and the Internet, in a wireless communication system including at least one wireless server connected to the Internet and the base station wireless apparatus connected to the wireless server, which performs wireless communication. The mobile wireless apparatus receives first data including destination information, which form a transmission packet transmitted by the base station wireless apparatus currently connected thereto by radio, and detects and determines a destination. When the destination of the transmission packet is not the mobile wireless apparatus, the mobile wireless apparatus receives a transmission channel of another base station wireless apparatus whose communication area is adjacent to that of the base station wireless apparatus during sending of second data subsequent to the first data which form the transmission packet. The mobile wireless apparatus detects and obtains electrical field intensity of the transmission channel.

Preferably, the mobile wireless apparatus obtains and stores channel information, which is included in the second data, of the other base station wireless apparatus whose communication area is adjacent to that of the base station wireless apparatus when it is determined that the destination of the transmission packet is the mobile wireless apparatus. The mobile wireless apparatus may receive a transmission channel of the other base station wireless apparatus based on the channel information.

Preferably, the mobile wireless apparatus stores information on the measured electrical field intensity of the transmission channel. The mobile wireless apparatus may detect an available base station wireless apparatus based on the information of the electrical field intensity when the mobile wireless apparatus moves outside the communication area covered by the base station wireless apparatus.

Preferably, the mobile wireless apparatus includes a receiving unit for receiving a radio signal, outputting received data, detecting electrical field intensity of the received radio signal, and outputting electrical field intensity data. A phase locked loop (PLL) unit, which is connected to the receiving unit, switches a reception channel of the receiving unit. A storage unit stores channel information associated with the base station wireless apparatus and the electrical field intensity data. An electrical field intensity obtaining unit stores the electrical field intensity data in the storage unit. A first data analyzing unit obtains a destination of the received data from the first data, gives a timing signal for storing the electrical field intensity data to the electrical field intensity obtaining unit, and causes the PLL unit to switch the reception channel of the receiving unit. A second data analyzing unit obtains channel information of the other base station wireless apparatus from the second data and stores the channel information in the storage unit.

In another aspect of the present invention, there is provided a base station wireless apparatus in a wireless communication system including at least one wireless server connected to the Internet and the base station wireless apparatus connected to the wireless server, which performs wireless communication with a mobile wireless apparatus that is connected to a terminal unit. The base station wireless apparatus adds an index to channel information, which is included in a transmission packet that is to be transmitted, of another base station wireless apparatus whose communication area is adjacent to that of the base station wireless apparatus based upon the distance between the base station wireless apparatus and the other base station wireless apparatus.

In another aspect of the present invention, there is provided a computer-readable medium for causing a computer to execute an electrical field intensity obtaining program in a mobile wireless apparatus. The program includes the steps of analyzing a packet transmitted from a base station wireless apparatus, determining a destination of the packet, and detecting and storing an electrical field intensity of a transmission channel of another base station wireless apparatus during sending of the packet when the destination of the packet is not the mobile wireless apparatus.

In another aspect of the present invention, there is provided a computer-readable medium for causing a computer to execute an index addition program in a base station wireless apparatus. The program includes the steps of obtaining positional information in accordance with a distance between the base station wireless apparatus and another peripheral base station wireless apparatus, adding an index to channel information that is included in a transmission packet based on the positional information in accordance with the distance between the base station wireless apparatuses and the other peripheral wireless apparatus, and transmitting the transmission packet that includes the channel information to which the index is added.

### BRIEF DESCRIPTION OF THE DRAWINGS

A more complete appreciation of the present invention and many of the attendant advantages thereof will be readily obtained as the same becomes better understood by reference to the following detailed description with accompanying drawings, wherein:

FIG. 1 is a block diagram of a mobile wireless apparatus according to an embodiment of the present invention;

FIG. 2 illustrates communication areas covered by a base station wireless apparatus A and by other base station wireless apparatuses according to an embodiment of the present invention;

FIG. 3 illustrates timing of a signal transmitted through a transmission channel of the base station wireless apparatus and timing of the operation of the mobile wireless apparatus according to an embodiment of the present invention;

FIG. 4 is a flowchart showing the operation of the mobile wireless apparatus according to an embodiment of the present invention;

FIG. 5 is a block diagram of a wireless communication system according to an embodiment of the present invention;

FIG. 6 illustrates a packet transmission process in the system of FIG. 5;

FIG. 7 is a flowchart showing the packet transmission process in the system of FIG. 5;

FIG. 8 is a flowchart showing the packet transmission to a terminal unit in a different communication area in the system of FIG. 5;

FIG. 9 is a flowchart showing the packet transmission process to a terminal unit in the system of FIG. 5;

FIG. 10 is a flowchart showing the packet transmission process to a host server in the system of FIG. 5;

FIG. 11 illustrates a process for issuing an address in the system of FIG. 5;

FIG. 12 illustrates the operation of terminal unit authentication in the system of FIG. 5; and

FIG. 13 illustrates the operation of terminal unit authentication in the system of FIG. 5.

### DETAILED DESCRIPTION OF THE PREFERRED EMBODIMENTS

The present invention will become clear from the following description of the preferred embodiments with reference to the accompanying drawings.

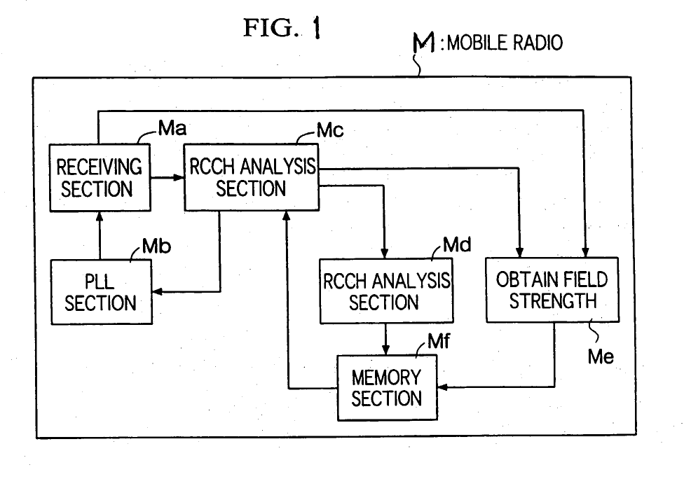

FIG. 1 is a block diagram of a mobile wireless apparatus M according to an embodiment of the present invention. The mobile wireless apparatus M can be employed in a wireless communication system as described in the above related art. Details of the mobile wireless apparatus M are described hereinafter.

Transmission packets transmitted from a base station wireless apparatus are described. The transmission packets are sent one after another through a transmission channel of the base station wireless apparatus. A frame within each transmission packet includes a set of a unique word (UW) and a radio control channel (RCCH) and a set of a common control channel (CCCH) or a user packet channel (UPCH) subsequent to the set of the UW and the RCCH. The UW, which is at the head of each frame is a bit string employed to synchronize frames. The UW is defined as a bit string that has a specific value. The RCCH includes information that indicates the state of radio links and designates a destination mobile wireless apparatus. The RCCH is received by all the mobile wireless apparatuses. The CCCH includes control information; e.g., a call request, and channel information associated with the peripheral base station wireless apparatuses. The CCCH is received by at least one mobile wireless apparatus that has been designated by the RCCH. The UPCH includes data to be transmitted to the mobile wireless apparatus. The UPCH is received by the designated mobile wireless apparatus designated by the RCCH.

Next, a structure of the mobile wireless apparatus M, according to one embodiment, is described. The mobile wireless apparatus M includes the following components: a receiving unit Ma, a phase locked loop (PLL), a storage unit Mf, an electrical field intensity obtaining unit Me, an RCCH analyzing unit Mc, and a CCCH analyzing unit Md. The receiving unit Ma receives a radio signal (transmission packet), outputs received data, detects the electrical field intensity of the received radio signal, and outputs electrical field intensity data. The PLL unit Mb, which includes a PLL circuit, connects to the receiving unit Ma, which switches a reception channel of the receiving unit Ma. The storage unit Mf stores channel information (e.g., frequency) of the base station wireless apparatus and the electrical field intensity data. The electrical field intensity obtaining unit Me stores the electrical field intensity data in the storage unit Mf. The RCCH analyzing unit Mc analyzes the RCCH within the received data to obtain a destination or the like, and provides a timing signal to the electrical field intensity obtaining unit Me to store the electrical field intensity data. In addition, the RCCH analyzing unit Mc causes the PLL unit Mb to switch the reception channel of the receiving unit Ma based on the channel information that is stored in the storage unit Mf. The CCCH analyzing unit Md analyzes the CCCH that is included in the received data when the RCCH analyzing unit Mc determines that the transmission packet is addressed to the mobile wireless apparatus M. The CCCH analyzing unit Md obtains channel information of the peripheral base stations, and stores the channel information in the storage unit Mf.

The mobile wireless apparatus M stores channel information of the major base station wireless apparatuses in the storage unit Mf before moving to another communication area. The base station wireless apparatus, or a wireless server that manages this base station wireless apparatus forms a wireless communication system. This base station or wireless server includes channel information of other base station wireless apparatuses that have adjacent communication areas. The base station wireless apparatus or the wireless server transmits the channel information by means of a transmission channel (i.e., down channel). The base station wireless apparatus and the mobile wireless apparatus are separately described hereinafter. The RCCH analyzing unit MC operates as a first data analyzing unit. The CCCH analyzing unit Md operates as a second data analyzing unit. The electrical field intensity obtaining unit Me operates as an electrical field intensity obtaining unit.

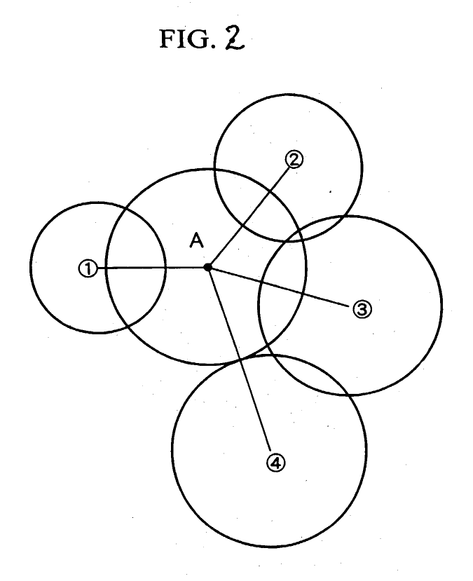

Referring to FIGS. 1 to 4, the operation of the mobile wireless apparatus M of this embodiment is described. As illustrated in FIG. 2, in this embodiment, for example, five adjacent communication areas corresponding to base station wireless apparatuses, in which a mobile wireless apparatus M is in the communication area that is covered by base station wireless apparatus A.

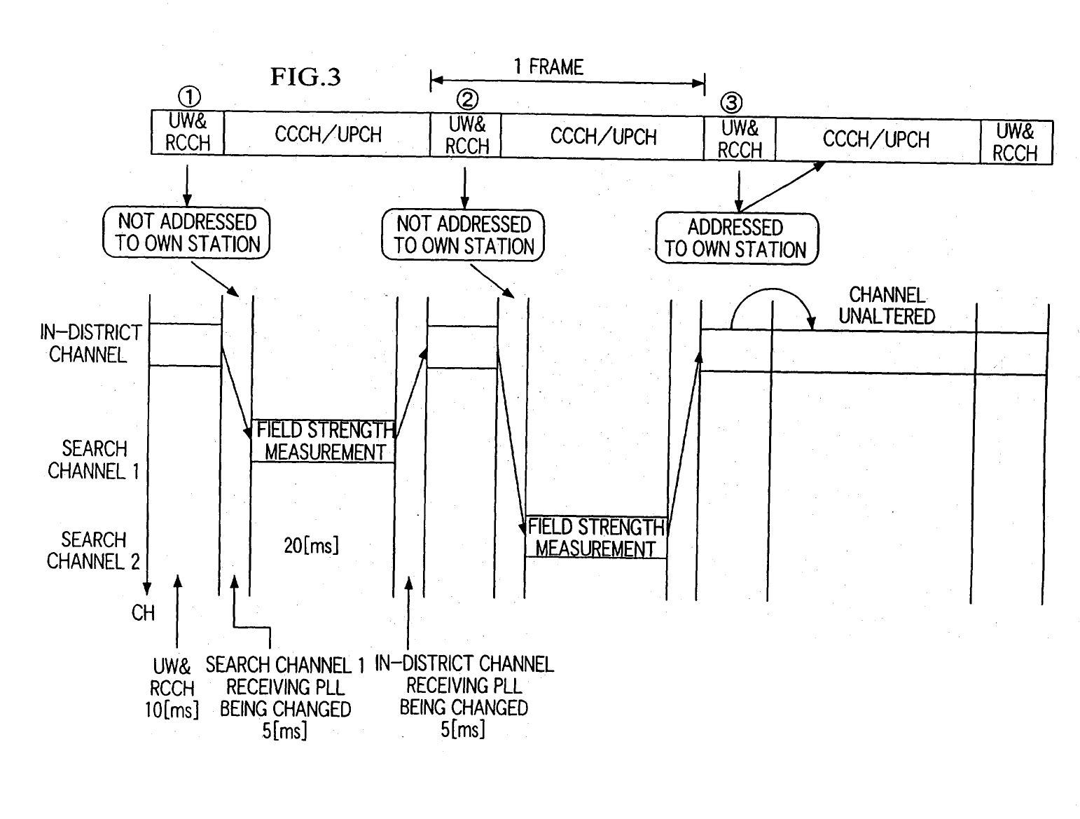

FIG. 3 shows the format of a transmission channel signal that is transmitted from the base station wireless apparatus A, the timing for transmitting data included in the signal, and the timing for obtaining the electrical field intensity of the transmission channels associated with other base station wireless apparatuses. According to an exemplary embodiment, the communication between the base station wireless apparatus and the mobile wireless apparatus is half-duplex. Specifically, the base station wireless apparatus constantly transmits packets using a down channel. In turn, the mobile wireless apparatus responds to the packet addressed thereto using an up channel.

For example, assuming the mobile wireless apparatus M has established radio communication with the base station wireless, the connection receiving unit Ma receives the transmission channel of the base station wireless apparatus A and receives an RCCH 1. The RCCH analyzing unit Mc analyzes the RCCH 1 that is received by the receiving unit Ma. In this example, the frame data, RCCH 1 is not addressed to the mobile wireless apparatus M. Thus, the RCCH analyzing unit Mc obtains channel information of another base station wireless apparatus from the storage unit Mf, and controls the PLL unit Mb to receive a transmission channel of this base station wireless apparatus.

After a lock time period has passed from the start of the channel switching operation by the PLL unit Mb, the receiving unit Ma may begin communication with a base station wireless apparatus B. Specifically, after the lock time period (e.g., five milliseconds) of the PLL unit Mb, the receiving unit Ma receives a transmission channel of a base station wireless apparatus, which is represented by a search channel 1 in FIG. 3 (numeral 1 in FIG. 2). The receiving unit Ma detects the electrical field intensity of the radio signal and outputs it to the electrical field intensity obtaining unit Me. Search channels 1, 2, and so forth correspond to transmission channels (frequencies) of other base station wireless apparatuses whose communication areas are adjacent to the communication area of the base station wireless apparatus A to which the mobile wireless apparatus M is connected by radio. An in-service-area channel represents the transmission channel (frequency) of the base station wireless apparatus A. Since the RCCH analyzing unit Mc controls the PLL unit Mb, the RCCH analyzing unit Mc is aware of the lock timing of the PLL unit Mb. The RCCH analyzing unit Mc sends a signal to designate the time for obtaining the electrical field intensity to the electrical field intensity obtaining unit Me. The electrical field intensity obtaining unit Me stores electrical field intensity data sent from the receiving unit Ma in the storage unit Mf within the designated time.

After the period that is required to obtain the electrical field intensity of the transmission channel (20 ms in the example shown in FIG. 3) elapses, the RCCH analyzing unit Mc obtains the channel information of the base station wireless apparatus A from the storage unit Mf, and controls the PLL unit Mb to receive the transmission channel of the base station wireless apparatus A. After the lock time period of the PLL unit Mb has passed, the receiving unit Ma receives the transmission channel of the base station wireless apparatus A, which is illustrated as an in-service area channel in FIG. 3.

The receiving unit Ma receives an RCCH 2, shown in FIG. 3. After the reception of the RCCH 2, the same operation with respect to RCCH 1 is performed. The exception is that, because the search channel 1 has already been detected, another transmission channel (search channel 2) is received, and the electrical field intensity of that transmission channel is obtained. Accordingly, when the received RCCH is not addressed to the mobile wireless apparatus M, transmission channels of other base station wireless apparatuses are scanned one after another, thereby obtaining the electrical field intensity thereof.

However, when the received RCCH 3 is addressed to the mobile wireless apparatus M, the electrical field intensity of a transmission channel of another base station wireless apparatus is not obtained. Under this scenario, the CCCH or the UPCH following the RCCH 3 is received by the mobile wireless apparatus M. When the data subsequent to the RCCH 3 is a CCCH, the CCCH is transferred from the RCCH analyzing unit Mc to the CCCH analyzing unit Md, which in turn analyzes the CCCH. If the CCCH includes channel information of another base station wireless apparatus whose communication area is adjacent to that of the base station wireless apparatus A, the channel information is stored in the storage unit Mf. A channel is addressed to the mobile wireless apparatus M in the following cases: the destination is the mobile wireless apparatus M alone; the destination is to a group including the mobile wireless apparatus M; and the destination is to all the mobile wireless apparatuses.

When the channel information includes an index that indicates the distance from the base station wireless apparatus A, the RCCH analyzing unit Mc serializes the search channels based on the distance information that is derived from the index when obtaining the electrical field intensity. Thus, a transmission channel of the nearest base station wireless apparatus is detected first because the mobile wireless apparatus M in the in-service area that is covered by the base station wireless apparatus A is likely to move into the communication area of the base station wireless apparatus that is closer to the base station wireless apparatus A. When the CCCH is a call request that is addressed to the mobile wireless apparatus M, the mobile wireless apparatus M uses a transmitting unit (not shown) to respond to the call request. In the example shown in FIG. 3, channel searches may be performed a maximum of 25 times per second (1000 ms 40 ms).

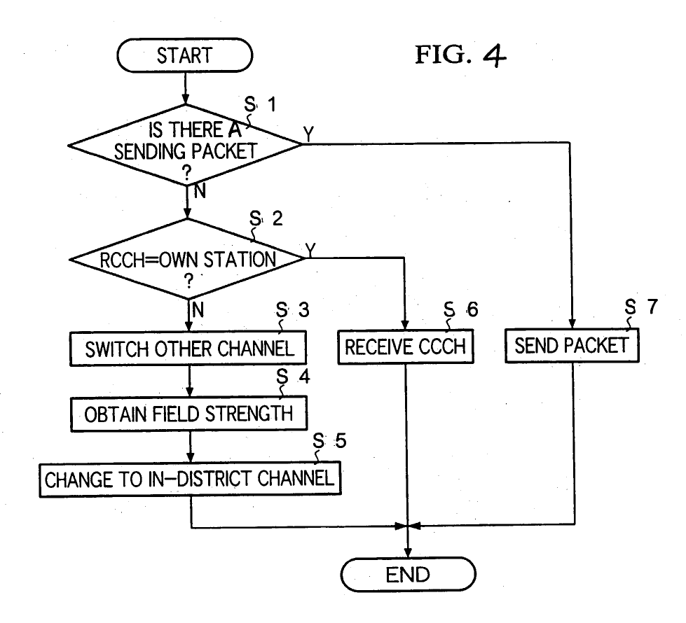

Referring now to FIG. 4, a flow chart of the operation of the mobile wireless apparatus M is shown. As in step S1, a transmission packet is examined to determine whether the packet is addressed from the mobile wireless apparatus M to the base station wireless apparatus A. If there is a packet to send, the transmission packet is transmitted (step S7), and the process is terminated. However, if there is no packet to send, a packet from the base station wireless apparatus A is received. The RCCH that is included in this packet is analyzed to determine whether the packet is addressed to the mobile wireless apparatus M (step S2). If the determination is affirmative, the CCCH or the UPCH subsequent to the RCCH is received (step S6). A predetermined processing is performed, and the process is terminated. However, if the determination is negative, the reception channel is switched to another base station wireless apparatus (step S3). In step S4, the electrical field intensity of the received transmission channel of the base station wireless apparatus is detected and stored. For example, the average of electrical field intensity that is detected for each channel in the last ten years may be stored, or alternatively, the strongest electrical field intensity in the last ten years may be stored.

Next, in step S5, the reception channel is changed back to the original base station wireless apparatus in the in-service area, and the process is terminated. The mobile wireless apparatus M repeats the above steps as necessary.

Accordingly, the mobile wireless apparatus M scans the transmission channels of base station wireless apparatuses one after another based on the channel information that is stored in the storage unit Mf, and obtains or measures the electrical field intensity. In this operation, if the time of the CCCH or the UPCH is greater than or equal to twice the lock time of the PLL unit plus the time required to obtain electrical field intensity, the transmission channels of the base station wireless apparatuses may be scanned one after another. By way of example, when one frame has a cycle of 40 ms (a set of the UW and the RCCH is 10 ms, and the CCCH or the UPCH is 30 ms) and when the time required to obtain the electrical field intensity is 20 ms, the following is possible. If the lock time of the PLL unit Mb is 5 ms or less, within one frame cycle, the mobile wireless apparatus M may receive a transmission channel of another base station unit, obtain the electrical field intensity of the received transmission channel, and then return to the transmission channel of the base station wireless apparatus connected thereto for receiving another transmission channel.

When the mobile wireless apparatus M is outside the in-service area of the base station wireless apparatus A, the apparatus M scans channels of the other base station wireless apparatuses in the manner described above. Accordingly, transmittable/receivable electrical field intensity information are stored in the storage unit Mf based upon the strength of the electrical field intensity (starting from the strongest to the weakest). Therefore, it is not necessary to scan untransmittable/unreceivable channels. It is possible to rapidly detect channels of base station wireless apparatuses whose communication areas may be in-service areas.

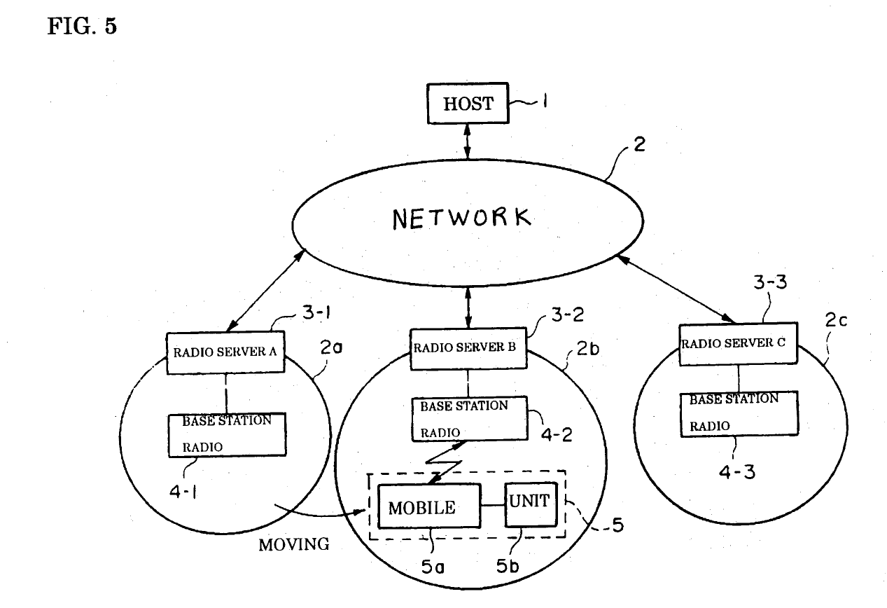

FIG. 5 is a block diagram of the wireless communication system according to an embodiment of the present invention. The wireless communication system includes a host server 1, a network 2 to which the host server 1 is connected, wireless servers 3-n that are connected to the network 2, sub-networks 2a, 2b, and 2c that are constructed under the control of the wireless servers 3-n, and base station wireless apparatuses 4-n that are connected to the wireless servers 3-n. Each of the base station wireless apparatuses 4-n are connected to a respective wireless server 3-n. The wireless communication system further includes a terminal unit 5 connected to the wireless server 3-n. The terminal unit 5 includes a mobile wireless apparatus (hereinafter referred to as a “mobile”) 5a, which communicates via radio with the base station wireless apparatuses 4-n and a computer terminal unit (hereinafter referred to as a “terminal”) 5b.

According to one embodiment of the present invention, the host server 1 includes a wireless server that communicates with a terminal unit by radio. Alternatively, the host server 1 need not be provided with wireless communication capability.

The terminal unit 5 can employ any one of the wireless servers 3-n, which is connected to the network 2, as a home server. In the example of FIG. 5, the home server of the terminal unit 5 is a wireless server C 3-3.

For the purposes of explanation, wireless servers X and Y correspond to two of the wireless servers 3-n in this embodiment. In addition, the base station wireless apparatuses A and B as described above correspond to any two of the base station wireless apparatuses 4-n. Further, the mobile wireless apparatus M described above corresponds to the mobile wireless apparatus 5a.

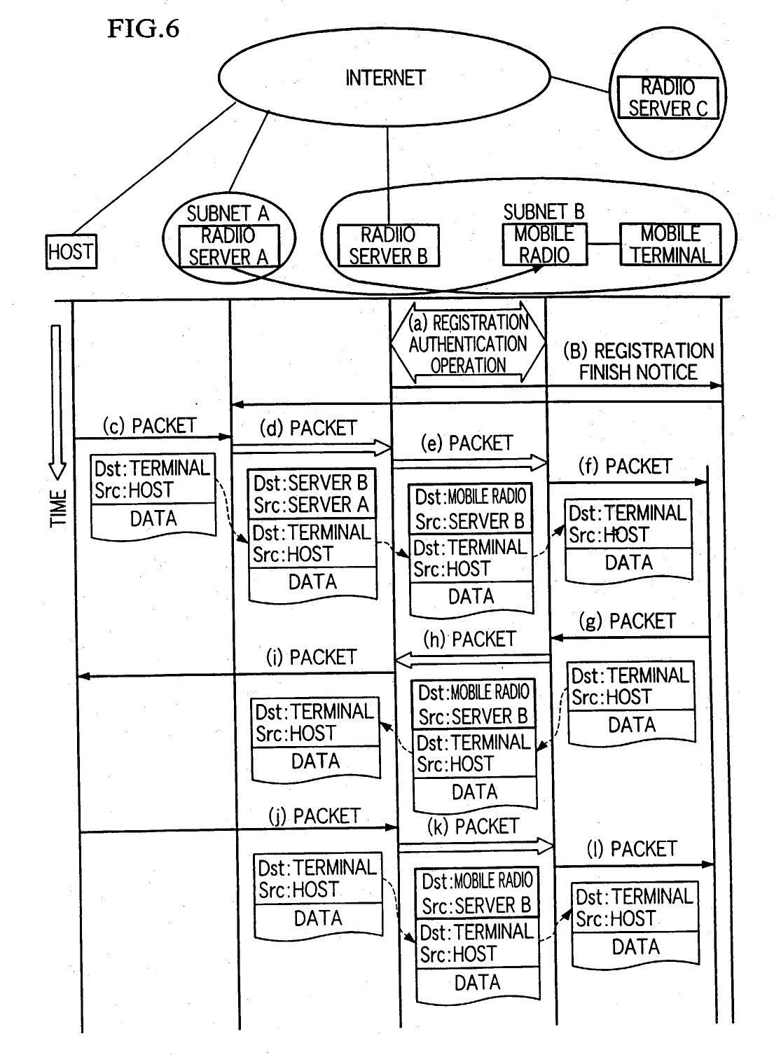

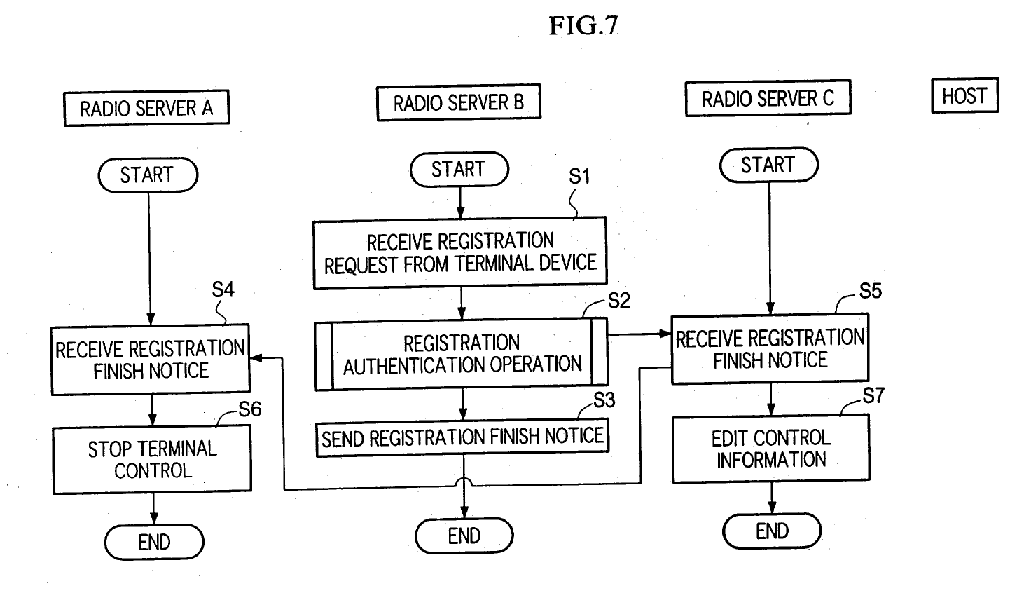

Referring now to FIGS. 6 to 10, the operation of the communication system of this embodiment is described. FIG. 6 illustrates a timing diagram of the operation of the wireless communication system according to an embodiment of the present invention. In FIG. 6, “Dst” represents a destination, and “Src” represents a source. FIGS. 7-10 are flowcharts showing various operations of the wireless communication system.

By way of example, it is assumed that the home server of the terminal unit 5 is the wireless server C 3-3 and the terminal unit 5 is under control of a wireless server A 3-1. Additionally, the terminal unit S moves from the sub-network 2a of the wireless server A 3-1 to the sub-network 2b of a wireless server B 3-2.

The terminal unit 5 issues requests to the wireless server B 3-2 to authenticate a terminal registration and for an IP address (refer to symbol (a) in FIG. 6 and step S1 in FIG. 7). In response to the request, the wireless server B 3-2 authenticates the registration and issues the IP address (refer to symbol (a) in FIG. 6 and step S2 in FIG. 7). Hence, the terminal unit 5 operates under the control of the wireless server B 3-2.

The registration authentication operation and the IP address issuing operation are described hereinafter. The wireless server B 3-2 notifies the home server 3-3 that the terminal unit 5 has moved from the communication area of the wireless server A 3-1 and to that of the wireless server B 3-2, completing the registration authentication (refer to symbol (b) in FIG. 6 and step S3 in FIG. 7).

In accordance with the completion notification of the registration from the wireless server B 3-2, the home server 3-3 notifies the wireless server A 3-1 that the terminal unit 5 is now under the control of the wireless server B 3-2 (step S5 in FIG. 7). The wireless server A 3-1 receives the notification of the registration completion (step S4 in FIG. 7), and stops the control of terminal unit 5 (step S6 in FIG. 7). The wireless server C 3-3 (as the home wireless server) records the fact that the terminal unit 5 is now under the control of the wireless server B 3-2, and updates the control information (step S7 in FIG. 7).

The home server 3-3 is notified of any movement of the terminal unit 5, so that the home server 3-3 wireless server is aware of the particular wireless server that is currently controlling the terminal unit 5. In this manner, the terminal unit 5 can move to any communication area of any one of wireless server.

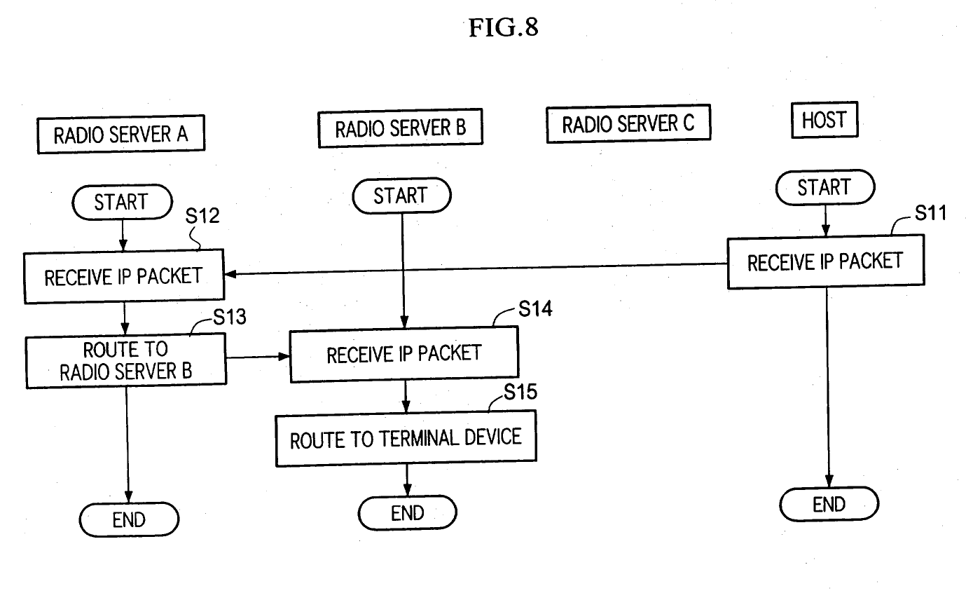

With reference to FIGS. 6 and 8, the operation of the host server 1 for transmitting a packet to the terminal unit 5 is described. The host server 1 transmits an IP packet via the network 2 (step S11 in FIG. 8). At this moment, the host server 1 does not know that the terminal unit 5 is under the control of the wireless server B 3-2. Thus, the transmission packet from the host server 1 is transmitted to the wireless server A 3-1 to which the terminal unit 5 was previously connected (symbol (c) in FIG. 6).

The wireless server A 3-1 receives the packet (step S12 in FIG. 8) and routes the packet to the wireless server B 3-2 (step S13 in FIG. 8 and symbol (d) in FIG. 6). The wireless server B 3-2 receives the packet (step S14 in FIG. 8). The wireless server B 3-2 routes the packet to the mobile 5a of the terminal unit 5, which is now under the control of wireless server B 3-2 (symbol (e) in FIG. 6 and step S15 in FIG. 8). The packet is also transmitted to the terminal 5b (symbol (f) in FIG. 6).

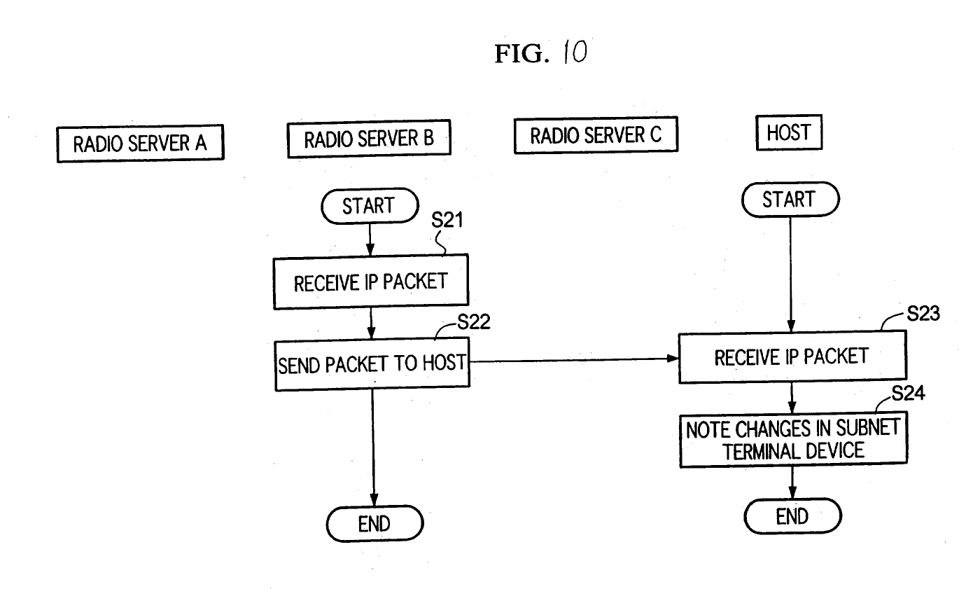

Referring now to FIGS. 6, 9, and 10, the operation of the terminal unit 5 for transmitting a packet to the host server 1 is described. The terminal 5b transmits the packet to the mobile 5a (symbol (g) in FIG. 6). The mobile 5a transmits the received packet via the wireless server B 3-2. The wireless server B 3-2 receives the packet (step S21 in FIG. 10), routes it to the host server 1, and transmits the IP packet received from the terminal unit 5 to the host server 1 (symbol (i) in FIG. 6 and step S22 in FIG. 10).

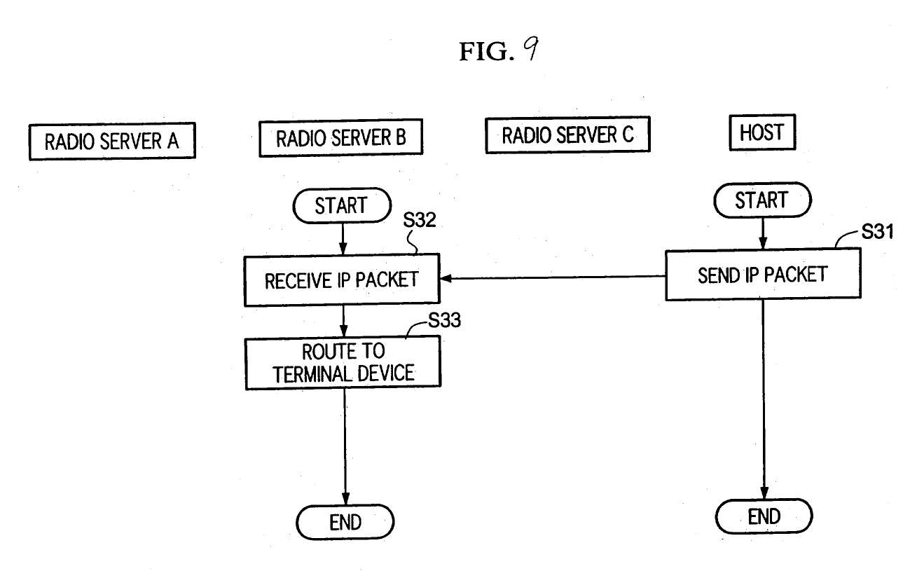

After, the host server 1 receives the packet (step S23 in FIG. 9), the host server 1 is alerted of the fact that terminal unit 5 is now under the control of the wireless server B 3-2 based on the address of the source of the packet (step S24 in FIG. 9). Subsequently, packets to the terminal unit 5 are transmitted directly to the wireless server B 3-2. That is, when the host server 1 transmits a packet that is destined to the wireless server B 3-2, the host server 1 first sends the packet to the wireless server B 3-2 (symbol (j) in FIG. 6 and step S31 in FIG. 9).

Upon receiving the packet (step S32 in FIG. 9), the wireless server B 3-2 routes the packet to the terminal unit 5 (step S33 in FIG. 9). Hence, the packet is transmitted to the mobile 5a of terminal unit 5 (symbol (k) in FIG. 6).

When the packet is transmitted to or received from the terminal unit 5, the IP packet is forwarded. It is noted that not all the hosts need to be notified about the position of the terminal unit 5 every time the terminal unit 5 moves, thereby preventing possible traffic congestion of communication links.

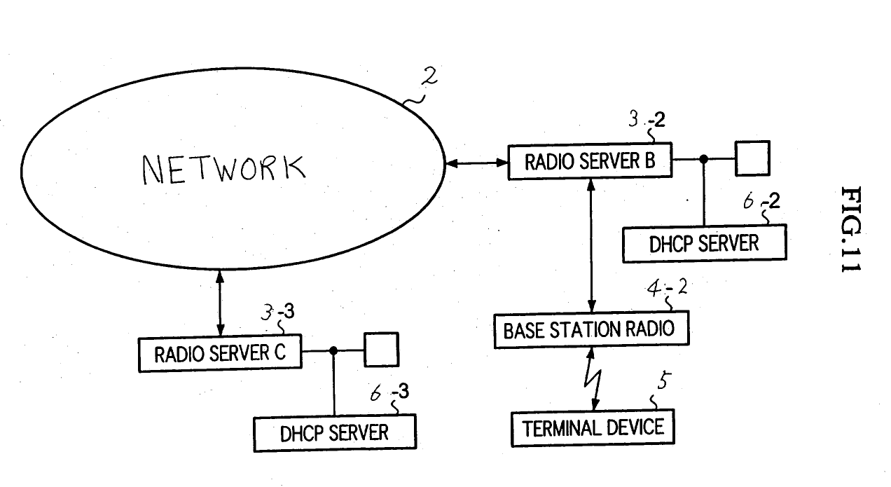

Referring to FIG. 11, the IP address issuing operation is described. As indicated above, when moved into the communication area covered by the wireless server B 3-2, the terminal unit 5 requests an IP address from the wireless server B 3-2. Accordingly, the wireless server B 3-2 indexes the home wireless server 3-3 of the terminal unit 5. Thereafter, the wireless server B 3-2 requests the wireless server C 3-3 to issue the IP address.

The IP address request is made to a dynamic host configuration protocol (DHCP) server 6-3, which is connected to the wireless server C 3-3 (the home server). In response to this request, the DHCP server 6-3 issues an available IP address, and notifies the wireless server C 3-3 of the issued IP address. The wireless server C 3-3 then passes the issued IP address via the wireless server B 3-2 to the terminal unit 5. In a scenario whereby the wireless server B 3-2 is the home server of terminal unit 5, DHCP server 6-2 would issue the IP address.

The IP address that is issued by the wireless server C 3-3 may be used by the terminal unit 5, which is under the control of the wireless server B 3-2. As a result, the terminal unit 5 operates as if it is under the control of the wireless server C 3-3. The packet is thereby transmitted via the wireless server B 3-2 to the terminal unit 5.

Accordingly, in response to the IP address issue request from the terminal unit 5, if the wireless server to which the terminal unit 5 is currently connected is not the home wireless server, the IP address is issued via this wireless server by the home wireless server. Thus, the terminal unit 5 may be connected to another wireless server without changing the setting of the IP address of the terminal unit 5.

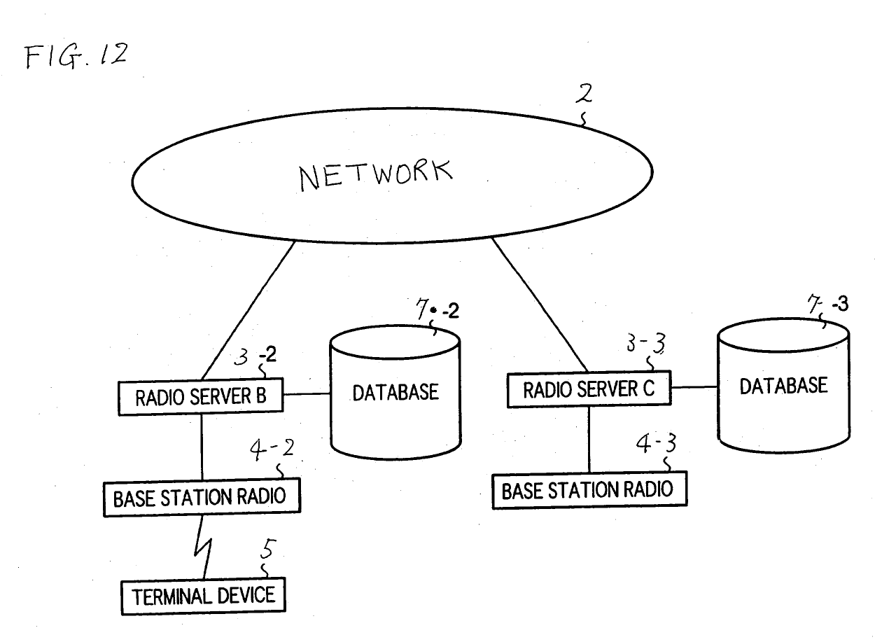

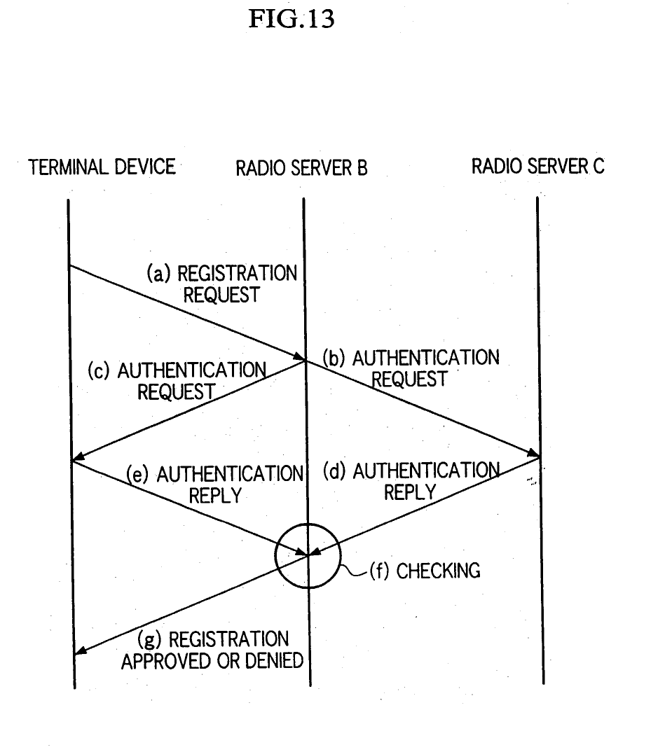

Referring now to FIGS. 12 and 13, the operation of registration authentication is described. The terminal unit 5 sends a registration request (symbol (a) in FIG. 13) and the identification number of the terminal unit 5 to the wireless server B 3-2. The wireless server B 3-2 then searches whether the authentication data of the terminal unit 5, for which the request has made, exists in a database 7-2 connected thereto. If the search result is negative, it is determined that the terminal unit 5 does not have the wireless server B 3-2 as the home server. The wireless server B 3-2 then indexes the home server of the terminal unit 5 based on the received identification number, and sends an authentication request to the indexed home server (the wireless server C 3-3 in this example) (symbol (b) in FIG. 13).

Simultaneously, a random value that is generated by the wireless server B 3-2 and the identification number of the terminal unit 5 that has made the registration request are added to the authentication request. Also, the random value is sent to the terminal unit 5 (symbol (c) in FIG. 13).

The wireless server C 3-3 as the home server receives the authentication request, and performs authentication processing based on the random value and the identification number. The wireless server C 3-3 sends the result of the authentication processing back to the wireless server B 3-2 (symbol (d) in FIG. 13).

The terminal unit 5 then performs authentication processing based on the random value that is received from the wireless server B 3-2, and sends the result back to the wireless server B 3-2 (symbol (e) in FIG. 13). The wireless server B 3-2 checks the authentication processing results received from the wireless server B 3-3 and from the terminal unit 5 (symbol (f) in FIG. 13). If the results are the same, the registration request is approved (symbol (g) in FIG. 13). If the results do not coincide with each other, they are regarded as invalid; and thus, the registration request is rejected.

In the case in which the authentication data is in database 7-2, the wireless server B 3-2 is the home server. Therefore, the authentication operation only requires the following steps: registration request (symbol (a) in FIG. 13), authentication request (symbol (c) in FIG. 13), authentication response. (symbol (e) in FIG. 13), and registration acceptance (symbol (g) in FIG. 13).

Accordingly, the terminal registration may be authenticated even if the terminal unit 5 is not under the control of a wireless server that is the home server.

Use of the above wireless communication system permits communication in an area in which the mobile terminal occupied even after the mobile terminal has moved. Such capability has particular application to message communication (electronic mail, Internet news, and file transfer via file transfer protocol (FTP)), voice mail, web delivery, computer telephony integration (CTI) (Internet telephone), synchro-communication, telemetry, and an intelligent transport system (ITS) (i.e., advanced road transportation system). With the routing function, the wireless communication system may be applied to push-type communication.

The various embodiments of the present invention, as discussed herein, utilize a base station wireless apparatus in a wireless communication system. However, it is understood by those skilled in the art that the present invention is not intended to limit the invention to those embodiments. The wireless communication system of the present invention may utilize networks, such as the Internet, an intranet, a local area network (LAN), and a dial-up network.

An electrical field intensity obtaining program may be recorded in a computer-readable medium for causing a computer system to execute the program in a mobile wireless apparatus, so that the mobile wireless apparatus obtains the electrical field intensity. Specifically, the above electrical field obtaining program causes the computer to execute an analyzing function that analyzes a packet sent from the base station wireless apparatus, a determining function that determines the destination of the packet, a detecting function that detects the electrical field intensity of a transmission channel of another base station wireless apparatus during sending of the packet when the destination of the packet is not the mobile wireless apparatus, and a recording function that records the detected electrical field intensity.

Further, an index addition program may be recorded in a computer-readable medium for causing a computer system to execute the program in a base station wireless apparatus, so that the base station wireless apparatus adds the index. Specifically, the above index addition program causes the computer to execute an obtaining function that obtains positional information in accordance with a distance between the base station wireless apparatus and another peripheral terminal station wireless apparatus, an adding function that adds an index to channel information within a transmission packet based on the positional information in accordance with the distance between the base station wireless apparatuses, and a sending function that sends the transmission packet including the channel information to which the index is added.

The computer system in the above description includes an operating system (OS) and hardware, such as peripheral equipment. Computer-readable recording medium refers to a portable medium, such as a floppy disk, a magneto-optical disk, a ROM, a CD-ROM, and to a storage device, such as a hard disk which is built into the computer system. The computer-readable recording medium further includes a storage device that dynamically stores a program for a short period of time, such as a communication link that is employed when sending a program via networks (e.g., the Internet), and communication links (e.g., telephone lines). Also, the computer-readable recording medium includes a storage device that stores a program for a predetermined period of time, such as a volatile memory in the computer system as a server or a client. The programs described above may cause the computer to execute some of the above functions, or alternatively, they may be combined with a program that has been recorded in advance in the computer system to execute all the functions.

Numerous modifications and variations of the present invention are possible in light of the above teachings. It is therefore to be understood that within the scope of the appended claims, the present invention may be practiced otherwise than as specifically described herein.

What is claimed as new and desired to be secured by Letters Patent of the United States is:

1. A mobile wireless apparatus comprising:
a receiving unit configured to receive a packet having a first data portion including destination information from a first base station wireless apparatus, the receiving unit detecting an electrical field intensity of a radio signal associated with the packet and outputting a corresponding electrical field intensity data; and
a radio control channel (RCCH) analyzing unit configured to determine a destination of the packet based upon the destination information, wherein the receiving unit selectively switches a reception channel to a second base station wireless apparatus that is adjacent to the base station wireless apparatus during receipt of a second data portion of the packet, the receiving unit detecting an electrical field intensity associated with the second base station wireless apparatus and outputting a corresponding electrical field intensity data.

2. The apparatus according to claim 1, further comprising:
a Common Control Channel (CCCH) analyzing unit configured to obtain channel information associated with the second base station wireless apparatus, wherein the channel information is included in the second data portion; and
a storage unit configured to store the channel information.

3. The apparatus according to claim 2, wherein the electrical field intensity data of the first base station wireless apparatus and the electrical field intensity data of the second base station wireless apparatus are stored in the storage unit, and upon the mobile wireless apparatus moving out of a communication area of the first base station wireless apparatus, the receiving unit switches the reception channel based upon the stored electrical field intensity data.

4. The apparatus according to claim 3, further comprising:
an electrical field intensity obtaining unit configured to instruct the storing of the electrical field intensity data in the storage unit in accordance with a timing signal from the RCCH analyzing unit; and
a Phase Locked Loop (PLL) unit coupled to the receiving unit configured to switch the reception channel.

5. The apparatus according to claim 1, wherein the electrical field intensity data of the first base station wireless apparatus and the electrical field intensity data of the second base station wireless apparatus are stored in the storage unit, and upon the mobile wireless apparatus moving out of a communication area of the first base station wireless apparatus, the receiving unit switches the reception channel based upon the plurality of electrical field intensity data.

6. A method of performing wireless communication with a plurality of base station wireless apparatuses, the method comprising:
receiving a packet having a first data portion that includes destination information from a first one of the base station wireless apparatuses;
detecting an electrical field intensity of a radio signal associated with the packet;
outputting an electrical field intensity data corresponding to the detected electrical field intensity;
determining a destination of the packet based upon the destination information;
receiving a second data portion of the packet;
selectively switching a reception channel to a second one of the base station wireless apparatuses that is adjacent to the first one of the base station wireless apparatus during the step of receiving the second data portion based upon the determining step; and
selectively detecting an electrical field intensity associated with the second base station wireless apparatus and outputting a corresponding electrical field intensity data.

7. The method according to claim 6, further comprising:
obtaining channel information associated with the second base station wireless apparatus, wherein the channel information is included in the second data portion; and
storing the channel information.

8. The method according to claim 7, further comprising:
storing the electrical field intensity data of the first base station wireless apparatus and the electrical field intensity data of the second base station wireless apparatus,
wherein the switching step is based upon the stored electrical field intensity data.

9. The method according to claim 8, further comprising:
instructing execution of the storing step in accordance with a timing signal from a RCCH analyzing unit,
wherein the switching step is performed by a Phase Locked Loop (PLL) unit.

10. The method according to claim 6, further comprising:
storing the electrical field intensity data of the first base station wireless apparatus and the electrical field intensity data of the second base station wireless apparatus,
wherein the switching step is based upon the stored electrical field intensity data.

11. A wireless communication system for providing communication between a host server and a terminal unit over a network, comprising:
a plurality of wireless servers connected to the network; and
a plurality of wireless base station apparatuses configured to communicate with the terminal unit, the plurality of wireless base station apparatuses correspondingly coupled to the plurality of wireless servers, each of the wireless base station apparatuses adding an index to channel information associated with each of the other wireless base station apparatuses that are adjacent.

12. The system according to claim 11, wherein one of the wireless servers being designated as a home server, the home server having positional information of the terminal unit within the communication areas of the wireless servers.

13. The system according to claim 11, wherein the network is an Internet Protocol (IP) based network.

14. The system according to claim 13, further comprising:
a dynamic host configuration protocol (DHCP) server coupled to one of the wireless servers to issue an IP address associated with the terminal unit.

15. A computer readable medium storing program instructions for execution on a computer system, which when executed by a computer, cause the computer to perform the steps of:
analyzing a packet that is transmitted from a base station wireless apparatus;
determining a destination of the packet based upon the analyzing step; and
detecting and storing electrical field intensity data associated with another base station wireless apparatus based upon the determining step.

16. The computer readable medium of claim 15, wherein the computer readable medium further stores program instructions for causing the computer to perform the step of:
selectively switching a reception channel to the other base station wireless apparatus based upon the stored electrical field intensity data.

17. A computer readable medium storing program instructions for execution on a computer system, which when executed by a computer, cause the computer to perform the steps of:
obtaining positional information based upon a distance between a base station wireless apparatus and a peripheral base station wireless apparatus;
adding an index to channel information within a packet based upon the positional information; and
transmitting the packet containing the added index.

18. The computer readable medium of claim 17, wherein the computer readable medium further stores program instructions for causing the computer to perform the steps of:
receiving a terminal registration request from a terminal unit; and
communicating the terminal registration request to a wireless server for authentication.
